(19) United States
(12) Patent Application Publication
(10) Pub. No.: US 2009/0006036 A1
(43) Pub. Date: Jan. 1, 2009

(54) Shared, Low Cost and Featureable Performance Monitor Unit

(75) Inventor: David Arnold Luick, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/769,005

(22) Filed: Jun. 27, 2007

(51) Int. Cl. G06F 15/00

(52) U.S. Cl. 702/186

(57) ABSTRACT

The present invention related to computer architecture, and more specifically to evaluating performance of processors. A performance monitor may be placed in an L2 cache nest of a processor. The performance monitor may monitor L2 cache accesses and receive performance data from one or more processor cores over a bus coupling the processor cores with the L2 cache nest. In one embodiment the bus may include additional lines for transferring performance data from the processor cores to the performance monitor.

### BACKGROUND OF THE INVENTION

1. Field of the Invention

The present invention relates to computer architecture, and more specifically to evaluating performance of processors.

2. Description of the Related Art

Modern computer systems typically contain several integrated circuits (ICs), including one or more processors which may be used to process information in the computer system. The data processed by a processor may include computer instructions which are executed by the processor as well as data which is manipulated by the processor using the computer instructions. The computer instructions and data are typically stored in a main memory in the computer system.

Processors typically process instructions by executing each instruction in a series of small steps. In some cases, to increase the number of instructions being processed by the processor (and therefore increase the speed of the processor), the processor may be pipelined. Pipelining refers to providing separate stages in a processor where each stage performs one or more of the small steps necessary to execute an instruction. In some cases, the pipeline (in addition to other circuitry) may be placed in a portion of the processor referred to as the processor core. Some processors may have multiple processor cores.

Even though increased processor speeds may be achieved using pipelining, the performance of a computer system may depend on a variety of other factors, for example, the nature of the memory hierarchy of the computer system. Accordingly, system developers generally study the access of instructions and data in memory and execution of instructions in the processors to gather performance parameters that may allow them to optimize system design for better performance. For example, system developers may study the cache miss rate to determine the optimal cache size, set associativity, and the like.

Modern processors typically include performance monitoring circuitry to instrument, test, and monitor various performance parameters. Such performance monitoring circuitry is typically centralized in a processor core, with large amounts of wiring routed to and from a plurality of other processor cores, thereby significantly increasing chip size, cost, and complexity. Moreover, after chip development and/or testing is complete, the performance monitoring circuitry is no longer needed, and recapturing the space occupied by the performance circuitry may not be possible.

Accordingly, what is needed are improved methods and systems for gathering performance parameters from a processor.

### SUMMARY OF THE INVENTION

The present invention related to computer architecture, and more specifically to evaluating performance of processors.

One embodiment of the invention provides a method for gathering performance data. The method generally comprises monitoring of L2 cache accesses by a performance monitor located in an L2 cache nest of a processor to capture performance data related to the L2 cache accesses. The method further comprises receiving, by the performance monitor, performance data from at least one processor core of the processor over a bus coupling the at least one processor core with the L2 cache nest, and computing one or more performance parameters based on at least one of the L2 cache accesses and the performance data received from the at least one processor core.

Another embodiment of the invention provides a performance monitor located in an L2 cache nest of a processor, wherein the performance monitor being configured to monitor accesses to a L2 cache in the L2 cache nest and compute one or more performance parameters related to the L2 cache accesses. The performance monitor is further configured to receive performance data from at least one processor core over a bus coupling the L2 cache nest with the at least one processor core.

Yet another embodiment of the invention provides a system generally comprising at least one processor core, an L2 cache nest comprising an L2 cache and a performance monitor, and a bus coupling the L2 cache nest with the at least one processor core. The performance monitor is generally configured to monitor L2 cache accesses to compute one or more performance parameters related to L2 cache access and receive performance data from the at least one processor core over the bus coupling the L2 cache nest with the at least one processor core.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates a processor according to an embodiment of the invention.

FIG. 3 illustrates another processor according to an embodiment of the invention.

### DETAILED DESCRIPTION OF THE PREFERRED EMBODIMENTS

The present invention relates to computer architecture, and more specifically to evaluating performance of processors. A performance monitor may be placed in an L2 cache nest of a processor. The performance monitor may monitor L2 cache accesses and receive performance data from one or more processor cores over a bus coupling the processor cores with the L2 cache nest. In one embodiment the bus may include one or more additional lines for transferring performance data from the processor cores to the performance monitor.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

### Exemplary System

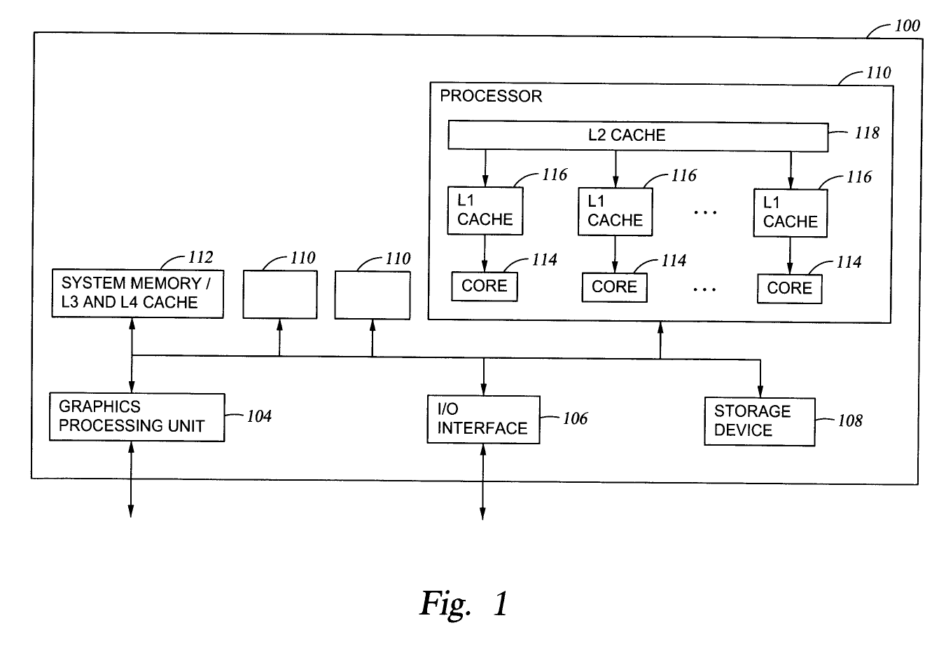

FIG. 1 illustrates an exemplary system 100 according to an embodiment of the invention. As illustrated, system 100 may include any combination of a plurality of processors 110, L3 cache/L4 cache/memory 112 (collectively referred to henceforth as memory), graphics processing unit (GPU) 104, input/output (10) interface 106, and a storage device 108. The memory 112 is preferably a random access memory sufficiently large to hold the necessary programming and data structures operated on by processor 110. While memory 112 is shown as a single entity, it should be understood that memory 112 may in fact comprise a plurality of modules, and that memory 112 may exist at multiple levels, for example, L3 cache, L4 cache, and main memory.

Storage device 108 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 108 could be part of one virtual address space spanning multiple primary and secondary storage devices.

IO interface 106 may provide an interface between the processors 110 and an input/output device. Exemplary input devices include, for example, keyboards, keypads, light-pens, touch-screens, track-balls, or speech recognition units, audio/video players, and the like. An output device can be any device to give output to the user, e.g., any conventional display screen.

Graphics processing unit (GPU) 104 may be configured to receive graphics data, for example, 2-Dimensional and 3-Dimensional graphics data, from a processor 110. GPU 106 may perform one or more computations to manipulate the graphics data, and render images on a display screen.

Processor 110 may include a plurality of processor cores 114. Processors cores 114 may be configured to perform pipelined execution of instructions retrieved from memory 112. Each processor core 114 may have an associated L1 cache 116. Each L1 cache 116 may be a relatively small memory cache located closest to an associated processor core 114 and may be configured to give the associated processor 114 fast access to instructions and data (collectively referred to henceforth as data).

Processor 110 may also include at least one L2 cache 118. An L2 cache 118 may be relatively larger than a L1 cache 114. Each L2 cache 118 may be associated with one or more L1 caches, and may be configured to provide data to the associated one or more L1 caches. For example a processor core 114 may request data that is not contained in its associated L1 cache. Consequently, data requested by the processor core 114 may be retrieved from an L2 cache 118 and stored in the L1 cache 116 associated with the processor core 114. In one embodiment of the invention, L1 cache 116, and L2 cache 118 may be SRAM based devices. However, one skilled in the art will recognize that L1 cache 116 and L2 cache 118 may include any other type of memory, for example, DRAM.

If a cache miss occurs in an L2 cache 118, data requested by a processor core 110 may be retrieved from an L3 cache 112. L3 cache 112 may be relatively larger than the L1 cache 116 and the L2 cache 118. While a single L3 cache 112 is shown in FIG. 1, one skilled in the art will recognize that a plurality of L3 caches 112 may also be implemented. Each L3 cache 112 may be associated with a plurality of L2 caches 118, and may be configured to exchange data with the associated L2 caches 118. One skilled in the art will also recognize that one or more higher levels of cache, for example, L4 cache may also be included in system 100. Each higher level cache may be associated with one or more caches of the next lower level.

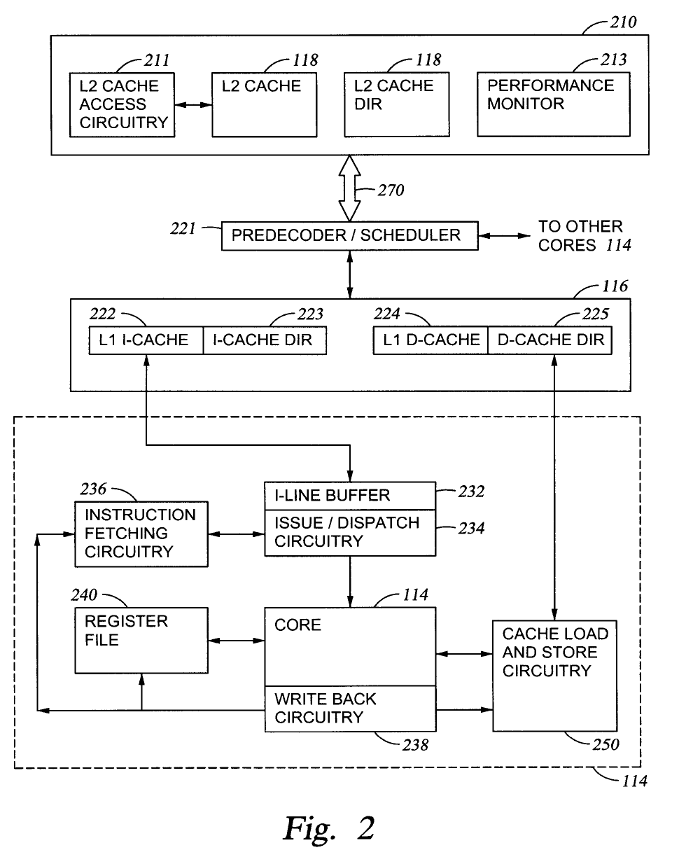

FIG. 2 is a block diagram depicting an exemplary detailed view of a processor 110 according to an embodiment of the invention. As illustrated in FIG. 2, processor 110 may include a L2 cache nest 210, L1 cache 116, predecoder/scheduler 221, and core 114. For simplicity, FIG. 2 depicts, and is described with respect to a single core 114 of the processor 110. In one embodiment, each core 114 may be identical (e.g., containing identical pipelines with the same arrangement of pipeline stages). For other embodiments, cores 114 may be different (e.g., containing different pipelines with different arrangements of pipeline stages).

L2 cache nest 210 may include L2 cache 118, L2 cache access circuitry 211, L2 cache directory 212, and performance monitor 213. In one embodiment of the invention, the L2 cache (and/or higher levels of cache, such as L3 and/or L4) may contain a portion of the instructions and data being used by the processor 110. In some cases, the processor 110 may request instructions and data which are not contained in the L2 cache 118. Where requested instructions and data are not contained in the L2 cache 118, the requested instructions and data may be retrieved (either from a higher level cache or system memory 112) and placed in the L2 cache. The L2 cache nest 210 may be shared between multiple processor cores 114.

In one embodiment, the L2 cache 118 may have an L2 cache directory 212 to track content currently in the L2 cache 118. When data is added to the L2 cache 118, a corresponding entry may be placed in the L2 cache directory 212. When data is removed from the L2 cache 118, the corresponding entry in the L2 cache directory 212 may be removed. Performance monitor 213 may monitor and collect performance related data for the processor 110. Performance monitoring is discussed in greater detail in the following section.

When the processor core 114 requests instructions from the L2 cache 118, the instructions may be transferred to the L1 cache 220, for example, via bus 270. As illustrated in FIG. 2, L1 cache 220 may include L1 Instruction-cache (L1 I-cache) 222, L1 I-Cache directory 223, L1 Data cache (L1 D-cache) 224, and L1 D-Cache directory 225. L1 I-Cache 222 and L1 D-Cache 224 may be a part of the L1 cache 116 illustrated in FIG. 1.

In one embodiment of the invention, instructions may be fetched from the L2 cache 118 in groups, referred to as I-lines. Similarly, data may be fetched from the L2 cache 118 in groups referred to as D-lines, via bus 270. I-lines may be stored in the I-cache 222 and D lines may be stored in D-cache 224. I-lines and D-lines may be fetched from the L2 cache 118 using L2 access circuitry 210.

In one embodiment of the invention, I-lines retrieved from the L2 cache 118 may first be processed by a predecoder and scheduler 221 and the I-lines may be placed in the I-cache 222. To further improve processor performance, instructions are often predecoded, for example, I-lines are retrieved from L2 (or higher) cache. Such predecoding may include various functions, such as address generation, branch prediction, and scheduling (determining an order in which the instructions should be issued), which is captured as dispatch information (a set of flags) that control instruction execution. For some embodiments, the predecoder (and scheduler) 221 may be shared among multiple cores 114 and L1 caches.

Core 114 may receive instructions from issue and dispatch circuitry 234, as illustrated in FIG. 2, and execute the instructions. In one embodiment, instruction fetching circuitry 236 may be used to fetch instructions for the core 114. For example, the instruction fetching circuitry 236 may contain a program counter which tracks the current instructions being executed in the core. A branch unit within the core may be used to change the program counter when a branch instruction is encountered. An I-line buffer 232 may be used to store instructions fetched from the L1 I-cache 222. Issue and dispatch circuitry 234 may be used to group instructions retrieved from the I-line buffer 232 into instruction groups which may then be issued in parallel to the core 114. In some cases, the issue and dispatch circuitry may use information provided by the predecoder and scheduler 221 to form appropriate instruction groups.

In addition to receiving instructions from the issue and dispatch circuitry 234, the core 114 may receive data from a variety of locations. For example, in some instances, the core 114 may require data from a data register, and a register file 240 may be accessed to obtain the data. Where the core 114 requires data from a memory location, cache load and store circuitry 250 may be used to load data from the D-cache 224. Where such a load is performed, a request for the required data may be issued to the D-cache 224. At the same time, the D-cache directory 225 may be checked to determine whether the desired data is located in the D-cache 224. Where the D-cache 224 contains the desired data, the D-cache directory 225 may indicate that the D-cache 224 contains the desired data and the D-cache access may be completed at some time afterwards. Where the D-cache 224 does not contain the desired data, the D-cache directory 225 may indicate that the D-cache 224 does not contain the desired data. Because the D-cache directory 225 may be accessed more quickly than the D-cache 224, a request for the desired data may be issued to the L2 cache 118 (e.g., using the L2 access circuitry 210) after the D-cache directory 225 is accessed but before the D-cache access is completed.

In some cases, data may be modified in the core 114. Modified data may be written to the register file, or stored in memory. Write back circuitry 238 may be used to write data back to the register file 240. In some cases, the write back circuitry 238 may utilize the cache load and store circuitry 250 to write data back to the D-cache 224. Optionally, the core 114 may access the cache load and store circuitry 250 directly to perform stores. In some cases, as described below, the write-back circuitry 238 may also be used to write instructions back to the I-cache 222.

As described above, the issue and dispatch circuitry 234 may be used to form instruction groups and issue the formed instruction groups to the core 114. The issue and dispatch circuitry 234 may also include circuitry to rotate and merge instructions in the I-line and thereby form an appropriate instruction group. Formation of issue groups may take into account several considerations, such as dependencies between the instructions in an issue group as well as optimizations which may be achieved from the ordering of instructions as described in greater detail below. Once an issue group is formed, the issue group may be dispatched in parallel to the processor core 114. In some cases, an instruction group may contain one instruction for each pipeline in the core 114. Optionally, the instruction group may a smaller number of instructions.

### Performance Monitoring

As discussed above, a performance monitor 213 may be included in the L2 cache nest 210, as illustrated in FIG. 2. Performance monitor 213 may comprise event detection and control logic, including counters, control registers, multiplexers, and the like. Performance monitor 213 may be configured to collect and analyze data related to the execution of instructions, interaction between the processor cores 114 and the memory hierarchy, and the like, to evaluate the performance of the system.

Exemplary parameters computed by the performance monitor 213 may include clock cycles per instruction (CPI), cache miss rates, Translation Lookaside Buffer (TLB) miss rates, cache hit times, cache miss penalties, and the like. In some embodiments, performance monitor 213 may monitor the occurrence of predetermined events, for example, access of particular memory locations, or the execution of predetermined instructions. In one embodiment of the invention, performance monitor 213 may be configured to determine a frequency of occurrence of a particular event, for example, a value representing the number of load instructions occurring per second or the number of store instructions occurring per second, and the like.

In prior art systems, the performance monitor was typically included in the processor core. Therefore, performance data from the L2 cache nest was sent to the performance monitor in the processor core over the bus 270 in prior art systems. However, the most significant performance statistics may involve L2 cache statistics, for example, L2 cache miss rates, TLB miss rates, and the like. Embodiments of the invention reduce the communication cost over bus 270 by including the performance monitor 213 in the L2 cache nest where the most significant performance data may be easily obtained.

Furthermore, by including the performance monitor in the L2 cache nest instead of the processor cores 114, the processor cores 114 may be made smaller and more efficient. Another advantage of including the performance monitor in the L2 cache nest may be that the performance monitor 213 can be operated at a lower clock frequency. In one embodiment, frequency of operation may not be significant to the working of the performance monitor 213. For example, the performance monitor 213 may collect a long trace of information over thousands of clock cycles to detect and compute performance parameters. A delay in getting the trace information to the performance monitor 213 may be acceptable, and therefore, operating the performance monitor at high speeds may not be necessary. By including the performance monitor 213 in the L2 cache nest instead of the processor core 114, the processor core 114 resources and space may be devoted to improving performance of the system.

In one embodiment of the invention, performance data may be transferred from a processor core 114 to a performance monitor 213 in the L2 cache nest 210. Exemplary performance data transferred from a processor core 114 to a performance monitor 213 may include, for example, data for computing the CPI of a processor core. In one embodiment of the invention, the performance data may be transferred from the processor core 114 to the performance monitor 213 over bus 270 during one or more dead cycles of the bus 270. A dead cycle may be a clock cycle in which data is not exchanged between the processor cores 114 and L2 cache 118 using bus 270. In other words, the performance data may be sent to the performance monitor 213 using the same bus 270 used for transferring L2 cache data to and from the processor cores 114 when the bus 270 is not being utilized for such L2 cache data transfers.

While a single processor core 114 is illustrated in FIG. 2, one skilled in the art will recognize that processor 110 may include a plurality of processor cores 114. In one embodiment of the invention, performance monitor 213 may be configured to receive performance data from each of the plurality of processor cores 114 of processor 110. In other words, embodiments of the invention may allow a performance monitor 213 to be shared between a plurality of processor cores 114. The performance data may be transferred using bus 270, thereby obviating the need for additional lines for transferring the performance data, and therefore, reducing chip complexity.

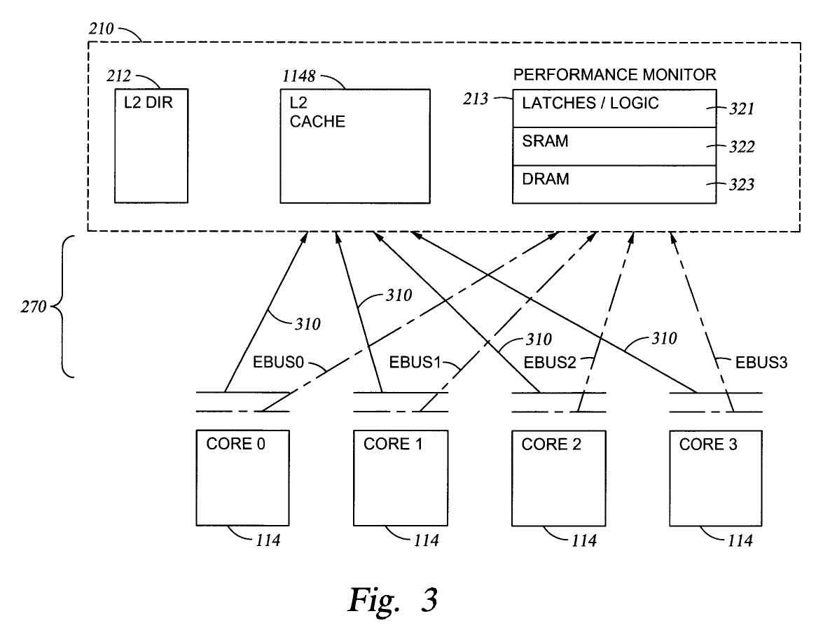

In one embodiment of the invention, bus 270 may include one or more additional lines for transferring data from a processor core 114 to the performance monitor 213. For example, in a particular embodiment, processor 110 may include four processor cores 114, as illustrated in FIG. 3. A bus 270 may connect the L2 cache nest to the processor cores 114. A first section of the bus 270 may be used for exchanging data between the processor cores and an L2 cache 118. A second section of the bus 270 may be used to exchange data between a performance monitor 213 and the processor cores.

For example, in a particular embodiment of the invention, bus 270 may be 144 bytes wide. A 128 byte wide section of the bus 270 may be used to transfer instructions and data from L2 cache 118 to the processor cores 114. A 16 byte wide section of the bus 270 may be used to transfer performance data from the processor cores 114 to the performance monitor 213 included in the L2 cache nest 210.

For example, referring to FIG. 3, an L2 cache nest 210 is illustrated comprising a L2 cache 118, L2 cache directory 212, and performance monitor 213 connected to cores 114 (four cores: core 0-core 3 are illustrated) via a bus 270. As illustrated in FIG. 3, bus 270 may include a first section 310 for transferring data to and from an L2 cache 118. The first section 310 of bus 270 may be coupled with each of the processor cores 114 as illustrated in FIG. 3. In one embodiment of the invention, the first section 310 may be a store through bus. In other words, data written to the L2 cache 118 via the first section 310 may also be stored in memory.

Bus 270 may also include a second section 320 for coupling the processors 114 with the performance monitor 213. For example, in FIG. 3, the section 320 includes buses EBUS0-EBUS3 for coupling each of processor cores 0-3 to the performance monitor 213. Performance data from each of the processor cores 114 may be sent to the performance monitor 213 via buses EBUS0-EBUS3.

While a second section 320 may be provided for transferring performance data from processor cores 114 to the performance monitor 213, one or more lines of the first section 310 may also be used for transferring performance data in addition to the second section 320. For example, during a dead cycle of bus section 310, one or more lines of bus section 310, in addition to the section 320, may be used for transferring performance data.

In one embodiment of the invention, the buses used to transfer performance data from the cores 114 to the performance monitor 213, for example, the buses EBUS0-EBUS3 of FIG. 3, may be formed with relatively thin wires. The buses EBUS0-EBUS3 may be formed with relatively thinner wires to conserve space. While thinner wires may result in a greater delay in transferring performance data from the processor cores 114 to the performance monitor 213, as described above, the delay may not be significant to the operation of the performance monitor and therefore the delay may be acceptable.

FIG. 3 also illustrates exemplary components of the performance monitor 213 according to an embodiment of the invention. As illustrated, performance monitor 213 may include latches/logic 321, Static Random Access Memory 322, and Dynamic Random Access Memory 323. The latches 321 may be used to capture data and events occurring in the L2 cache nest 210 and/or the bus 270. The logic 321 may be used to analyze captured data contained in the latches, SRAM 322, and/or the DRAM 323 to compute a performance parameter, for example, a cache miss rate.

In one embodiment of the invention, the SRAM 322 may serve as an buffer for transferring performance data to the DRAM 323. In one embodiment of the invention, the SRAM 322 may be an asynchronous buffer. For example, performance data may be stored in SRAM 322 at a first clock frequency, for example, the frequency at which the processor cores 114 operate. The performance data may be transferred from the SRAM 322 to the DRAM 323 at a second clock frequency, for example, the frequency at which the performance monitor 213 operates. By providing an asynchronous SRAM buffer, performance data may be captured from the cores 114 at a core frequency and analysis of the data may be performed at a performance monitor frequency. As described above, the performance monitor frequency may be lower than the core frequency.

One advantage of including a DRAM 323 in the performance monitor 213 may be that DRAM devices are typically much denser and require much less space than SRAM devices. Therefore, the memory available to the performance monitor may be greatly increased, thereby allowing the performance monitor to be efficiently shared between multiple processor cores 114.

### Conclusion

By including the performance monitor in the L2 cache nest, embodiments of the invention allow processor cores to become smaller and more efficient. Furthermore, because the most significant performance parameters are obtained in the L2 cache nest, the communication over a bus coupling the L2 cache nest and processor cores is greatly reduced.

While the foregoing is directed to embodiments of the present invention, other and further embodiments of the invention may be devised without departing from the basic scope thereof, and the scope thereof is determined by the claims that follow.

What is claimed is:

1. A method for gathering performance data, comprising:
monitoring of L2 cache accesses by a performance monitor located in an L2 cache nest of a processor to capture performance data related to the L2 cache accesses;
receiving, by the performance monitor, performance data from at least one processor core of the processor over a bus coupling the at least one processor core with the L2 cache nest; and
computing one or more performance parameters based on at least one of the L2 cache accesses and the performance data received from the at least one processor core.

2. The method of claim 1, wherein the bus coupling the L2 cache nest with the at least one processor core comprises a first set of bus lines for transferring the performance data to the performance monitor, and a second set of bus lines for exchanging data between the L2 cache and the at least one processor core.

3. The method of claim 2, wherein the first set of bus lines are relatively thinner than the second set of bus lines.

4. The method of claim 1, wherein the at least one processor core transfers the performance data over the bus when the bus is not being used for exchanging data with the L2 cache.

5. The method of claim 1, wherein the performance monitor comprises one or more latches for capturing performance data in the L2 cache nest and the bus.

6. The method of claim 1, wherein the performance monitor comprises control logic for computing the one or more performance parameters based on the L2 cache accesses and the performance data received from the at least one processor core.

7. The method of claim 1, wherein the performance monitor comprises dynamic random access memory (DRAM) for storing performance data.

8. The method of claim 7, wherein the performance monitor comprises static random access memory (SRAM), wherein the SRAM receives the performance data from the at least one processor core at a first frequency and transfers the performance data to the DRAM at a second frequency, wherein the first frequency is greater than the second frequency.

9. A performance monitor located in an L2 cache nest of a processor, the performance monitor being configured to:
monitor accesses to a L2 cache in the L2 cache nest and compute one or more performance parameters related to the L2 cache accesses; and
receive performance data from at least one processor core over a bus coupling the L2 cache nest with the at least one processor core.

10. The performance monitor of claim 9, wherein the bus coupling the L2 cache nest with the at least one processor core comprises a first set of bus lines for transferring the performance data to the performance monitor, and a second set of bus lines for exchanging data between the L2 cache and the at least one processor core.

11. The performance monitor of claim 9, wherein the first set of bus lines are relatively thinner than the second set of bus lines.

12. The performance monitor of claim 9, wherein the at least one processor core is configured to transfer the performance data over the bus when the bus is not being used for exchanging data with the L2 cache.

13. The performance monitor of claim 9, wherein the performance monitor comprises one or more latches, wherein the one or more latches are configured to capture performance data in the L2 cache nest and the bus.

14. The performance monitor of claim 9, wherein the performance monitor comprises control logic for computing one or more performance parameters based on the L2 cache accesses and the performance data received from the at least one processor core.

15. The performance monitor of claim 9, wherein the performance monitor comprises dynamic random access memory (DRAM) for storing performance data.

16. The performance monitor of claim 15, wherein the performance monitor comprises static random access memory (SRAM), wherein the SRAM is configured to receive the performance data from the at least one processor core at a first frequency and transfer the performance data to the DRAM at a second frequency, wherein the first frequency is greater than the second frequency.

17. A system comprising:
at least one processor core;
an L2 cache nest comprising an L2 cache and a performance monitor; and
a bus coupling the L2 cache nest with the at least one processor core, wherein the performance monitor is configured to:
monitor L2 cache accesses to compute one or more performance parameters related to L2 cache access; and
receive performance data from the at least one processor core over the bus coupling the L2 cache nest with the at least one processor core.

18. The system of claim 17, wherein the bus comprises a first set of bus lines for transferring the performance data to the performance monitor, and a second set of bus lines for exchanging data between the L2 cache and the at least one processor core.

19. The system of claim 18, wherein the first set of bus lines are relatively thinner than the second set of bus lines.

20. The system of claim 17, wherein the at least one processor core is configured to transfer the performance data over the bus when the bus is not being used for exchanging data with the L2 cache.

21. The system of claim 17, wherein the performance monitor comprises:
one or more latches;
control logic for capturing and computing one or more performance parameters;
a static random access memory (SRAM); and
a dynamic random access memory (DRAM).

22. The system of claim 21, wherein the SRAM is configured to receive the performance data from the at least one processor core at a first frequency and transfer the performance data to the DRAM at a second frequency, wherein the first frequency is greater than the second frequency.
